(19) United States
(12) Patent Application Publication
(10) Pub. No.: US 2007/0040507 A1
(43) Pub. Date: Feb. 22, 2007

(54) Plasma display panel (PDP)

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: Robert E. Bushnell, Suite 300, 1522 K Street, N.W., Washington, DC, 20005, US

(21) Appl. No.: 11/496,617

(22) Filed: Aug. 1, 2006

(30) Foreign Application Priority Data
Aug. 19, 2005 (KR) 10-2005-0076367

(51) Int. Cl. H01J 17/49

(52) U.S. Cl. 313/583; 313/582; 315/169.4; 345/60

(57) ABSTRACT

A Plasma Display Panel (PDP) that prevents bad terminal portions of discharge electrodes includes: a pair of substrates spaced apart from each other and facing each other; a sheet interposed between the pair of substrates and including barrier rib portions partitioning discharge cells, along with the pair of substrates, and dielectric ribs arranged on edges of the sheet; discharge electrodes including discharge portions arranged in the barrier rib part portions and adapted to effect a discharge, terminal portions contacting the dielectric ribs, having a thickness of 0.5˜2 μm, and spaced apart from each other, and connection portions connecting the discharge portions and the terminal portions; a signal transmitting element including conductive wires contacting the terminal portions and spaced apart from each other; phosphor layers arranged within the discharge cells; and a discharge gas contained within the discharge cells.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on the 19^{th} of Aug. 2005 and there duly assigned Ser. No. 10-2005-0076367.

### BACKGROUND OF THE INVENTION

1. Field of the Invention

The present invention relates to a Plasma Display Panel (PDP) and, more particularly, to a PDP that prevents defects in terminal portions of discharge electrodes.

2. Description of the Related Art

Plasma display panels (PDP) have replaced conventional Cathode Ray Tubes (CRTs) and display desired images using visible light rays generated by sealing discharge gas and supplying a discharge voltage between two substrates on which a plurality of electrodes are formed to generate vacuum ultraviolet rays which excite phosphors on which the vacuum ultraviolet rays are irradiated on in a predetermined pattern.

A plasma display includes a PDP having a front substrate and a rear substrate that face each other, and a plurality of discharge electrodes interposed between the front and rear substrates, and a circuit substrate that operates the PDP.

The discharge electrodes include a plurality of address electrodes that generate an address discharge and a plurality of sustain electrodes that sustain a discharge. Each of the discharge electrodes is electrically connected to the circuit substrate via a signal transmitting element.

Address electrodes of the discharge electrodes of a PDP are formed on a rear substrate and include discharge portions, connection portions, and the terminal portions. The terminal portions are electrically connected to each of a plurality of conductive wires forming signal transmitting element.

If an electrical signal is generated from a circuit substrate, the electrical signal is transferred to the discharge portions via the signal transmitting element, the terminal portions, and the connection portions and generates an address discharge, together with a discharge electrode that serves as a scan electrode of the sustain electrodes.

Since the terminal portions are connected to each of the conductive wires forming the signal transmitting element, a gap between the terminal portions is narrower than a gap between the discharge portion.

However, in such a PDP, the discharge portions, the connection portions, and the terminal portions are formed of the same material and the thickness of the terminal portions is almost identical to that of the discharge portions and the connection portions.

Therefore, the terminal portions of such a PDP are often shorted due to an electrode migration and an impurity migration between the terminal portions and other substances.

### SUMMARY OF THE INVENTION

The present invention provides a plasma display panel (PDP) that can prevent a defect in a terminal part of discharge electrodes.

According to one aspect of the present invention, a Plasma Display Panel (PDP) is provided including: a pair of substrates spaced apart from each other and facing each other; a sheet interposed between the pair of substrates and including barrier rib portions partitioning discharge cells, along with the pair of substrates, and dielectric rib portions arranged on edges of the sheet; discharge electrodes including discharge portions arranged within the barrier rib portions and adapted to effect a discharge, terminal portions contacting the dielectric ribs, having a thickness of 0.5˜2 μm, and spaced apart from each other, and connection portions connecting the discharge portions to the terminal portions; a signal transmitting element including conductive wires contacting the terminal portions and spaced apart from each other; phosphor layers arranged within the discharge cells; and a discharge gas contained within the discharge cells.

The discharge portions preferably surround at least part of the discharge cells. The discharge portions are preferably stripe-shaped.

The terminal portions preferably include a different material from that of the discharge portions. The terminal portions preferably include a different material from that of the connection portions. The terminal portions preferably include a material selected from a group consisting of Cr/Cu/Cr, Ag, Cu, and Al. A width of the terminal portions is preferably smaller than a width of the conductive wire of the signal transmitting element.

The signal transmitting element preferably includes a Flexible Printed Cable (FPC). The signal transmitting element alternatively preferably includes a Tape Carrier Package (TCP).

The conductive wires of the signal transmitting element and the terminal portions are preferably connected via an anisotropic conductive film.

According to another aspect of the present invention, a Plasma Display Panel (PDP) is provided including: a pair of substrates spaced apart from each other and facing each other; barrier rib portions interposed between the pair of substrates and partitioning discharge cells, along with the pair of substrates; discharge electrodes including discharge portions arranged in the pair of substrates and adapted to effect a discharge, terminal portions having a thickness of 0.5˜2 μm and spaced apart from each other, and connection portions connecting the discharge portions to the terminal portions; a signal transmitting element including conductive wires contacting the terminal portions and spaced apart from each other; phosphor layers arranged within the discharge cells; and a discharge gas contained within the discharge cells.

The discharge portions preferably surround at least part of the discharge cells. The discharge portions are preferably stripe-shaped.

The terminal portions preferably include a same material as that of the discharge portions. The terminal portions preferably include a different material from that of the connection portions. The terminal portions preferably include a material selected from a group consisting of Cr/Cu/Cr, Ag, Cu, and Al. A width of the terminal portions is preferably smaller than a width of the conductive wire of the signal transmitting element.

The signal transmitting element preferably includes a Flexible Printed Cable (FPC). The signal transmitting element alternatively preferably includes a Tape Carrier Package (TCP).

The conductive wires of the signal transmitting element and the terminal portions are preferably connected via an anisotropic conductive film.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a plan view of terminal portions of address electrodes included in discharge electrodes of a Plasma Display Panel (PDP);

FIG. 2 is a magnifying view of a portion A of FIG. 1;

FIG. 3 is a partially exploded perspective view of a PDP according to an embodiment of the present invention;

FIG. 4 is a cross-sectional view of the PDP of FIG. 3 taken along line IV-IV of FIG. 2;

FIG. 5 is a cross-sectional view of the PDP of FIG. 3 taken along line V-V of FIG. 3;

FIG. 6 is a partially exploded perspective view of a PDP according to another embodiment of the present invention;

FIG. 7 is a cross-sectional view of the PDP of FIG. 6 taken along line VII-VII of FIG. 6; and

FIG. 8 is a cross-sectional view of the PDP of FIG. 6 taken along line VIII-VIII of FIG. 7.

### DETAILED DESCRIPTION OF THE INVENTION

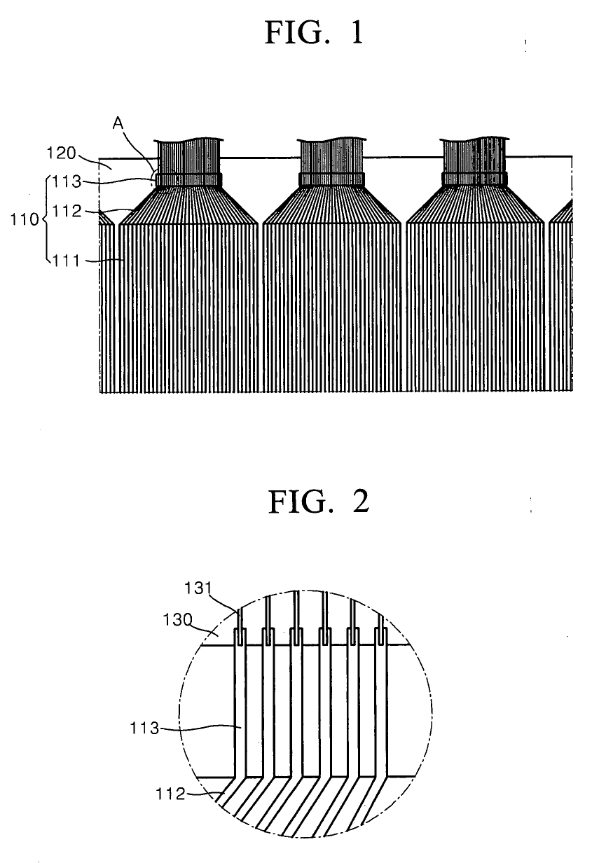

FIG. 1 is a plan view of terminal portions 113 of address electrodes 110 among discharge electrodes of a Plasma Display Panel (PDP). FIG. 2 is a magnifying view of a portion A of FIG. 1.

Referring to FIGS. 1 and 2, the address electrodes 110 are formed on a rear substrate 120 and include discharge portions 111, connection portions 112, and the terminal portions 113. The terminal portions 113 are electrically connected to each of a plurality of conductive wires 131 forming a signal transmitting element 130.

If an electrical signal is generated by a circuit substrate, the electrical signal is transferred to the discharge portions 111 via the signal transmitting element 130, the terminal portions 113, and the connection portions 112 and generates an address discharge, together with a discharge electrode that serves as a scan electrode among the sustain electrodes.

Since the terminal portions 113 are connected to each of the conductive wires 131 forming the signal transmitting element 130, a gap between the terminal portions 113 is narrower than a gap between the discharge portion 111.

However, in the PDP of FIG. 1, the discharge portions 111, the connection portions 112, and the terminal portions 113 are formed of the same material and the thickness of the terminal portions 113 is almost identical to that of the discharge portions 111 and the connection portions 112.

Therefore, the terminal portions 113 of the PDP of FIG. 1 are often shorted due to an electrode migration and an impurity migration between the terminal portions 113 and other substances.

The present invention is described more fully below with reference to the accompanying drawings, in which exemplary embodiments of the present invention are shown.

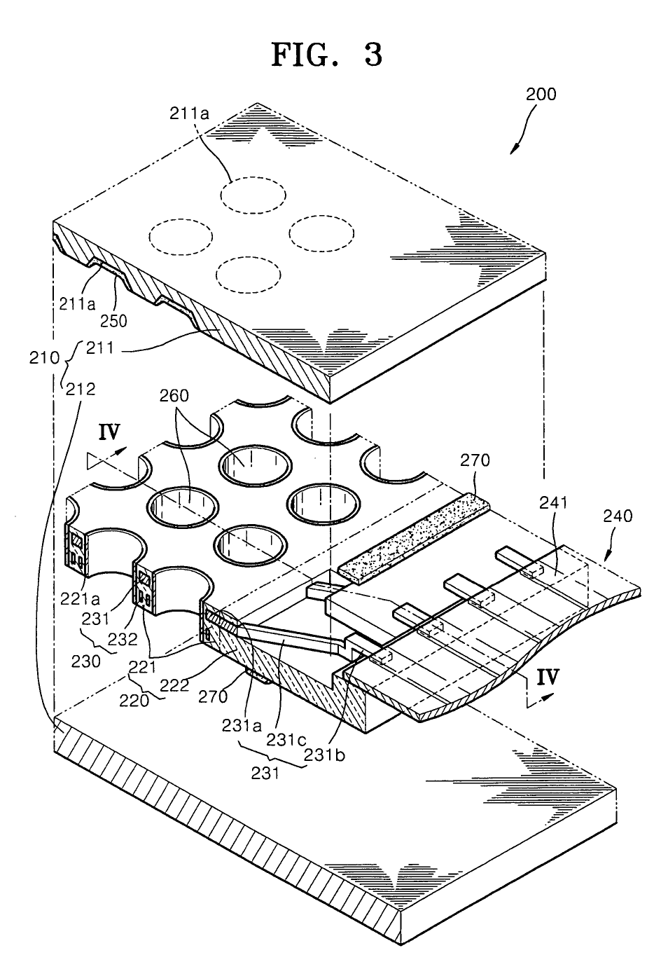

A Plasma Display Panel (PDP) 200 according to an embodiment of the present invention is described below with reference to FIGS. 3 through 5.

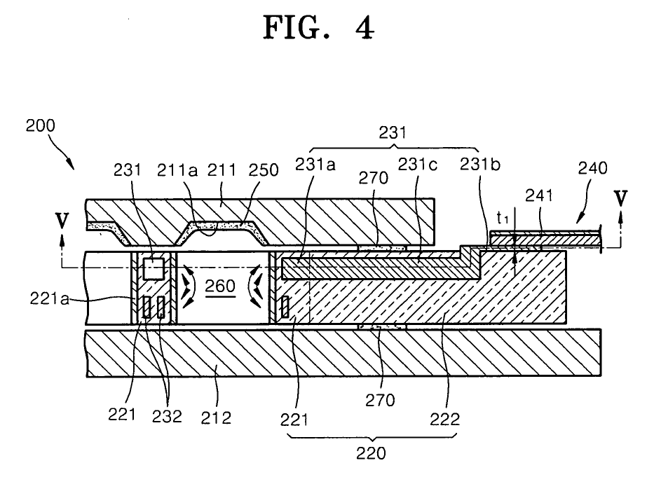

Referring to FIGS. 3 and 4, the PDP 200 includes a pair of substrates 210, a pair of sheets 220, a pair of discharge electrodes 230, a signal transmitting element 240, and a phosphor layer 250.

The pair of substrates 210 is a first substrate 211 and a second substrate 212 which are spaced apart from each other by a predetermined gap and face each other. The first substrate 211, which is transparent, is formed of glass through which visible light is transmitted.

In the current embodiment, since the first substrate 211 is transparent, the visible light generated by a discharge is transmitted through the first substrate 211. However, the present invention is not necessarily restricted thereto. In more detail, the first substrate 211 can be formed of an opaque material whereas the second substrate 212 can be formed of a transparent material, or the first and second substrates 211 and 212 can both be formed of a transparent material. Also, the first and second substrates 211 and 212 can be formed of a translucent material serving as a color filter.

The pair of sheets 220 are interposed between the pair of the substrates 210 and include barrier rib portions 221 and a dielectric portion 222.

The barrier rib portions 221 partition discharge cells 260 where a discharge is generated, together with the substrates 210 to partition display regions where an image is displayed.

The dielectric portion 222 is connected to the barrier rib portions 221 and is arranged in edges of the sheets 220.

The barrier rib portions 221 of the current embodiment of the present invention partition the discharge cells 260 whose inside is coated with the phosphor layer 250 and partition display regions where the image is displayed. However, the present invention is not necessarily restricted thereto. In more detail, the barrier rib portions 221 can partition dummy discharge cells where the image is not displayed. The dummy discharge cells do not include a discharge electrode or a phosphor layer and do not effect a discharge. In this case, the dummy discharge cells can be formed along the inside of the dielectric portion 222 and between the discharge cells 260.

In the current embodiment of the present invention, the discharge cells 260 have circular cross-sections. However, the present invention is not necessarily restricted thereto, and the discharge cells 260 can have other cross-sections, such as a triangle, a tetragon, an octagon, etc. or an oval.

A dielectric substance forming the barrier rib portions 221 prevents the discharge electrodes 230 from sending a current therebetween when a sustain discharge is generated, and thereby prevents damage due to collisions between charged particles and the discharge 5 electrodes 230, thereby accumulating wall charges by inducing the charged particles. The dielectric substance can be PbO, B₂O₃, SiO₂, etc.

The dielectric portion 222 and the barrier rib portions 221 are formed of the same dielectric substance. However, the present invention is not necessarily restricted thereto. The dielectric portion 222 and the barrier rib portions 221 can be formed of different dielectric substance. In this case, since a discharge is not generated in the dielectric portion 222, a dielectric substance can be selected by properly adjusting the dielectric characteristics.

Protection layers 221a, formed of magnesium oxide (MgO), cover sides of the barrier rib portions 221 and prevent the barrier rib portions 221 and the discharge electrodes 230 from being damaged due to sputtering of plasma particles, discharge secondary electrons, and reduce a discharge voltage.

The discharge electrodes 230 include a first discharge electrode 231 and a second discharge electrode 232 spaced apart from the first discharge electrode 231.

The first discharge electrode 231 includes discharge portions 231a, terminal portions 231b, and connection portions 231c.

The discharge portions 231a are arranged inside the barrier rib portions 221, directly effect a discharge, have a thickness of about 5˜10 μm, and are formed of copper (Cu).

The discharge portions 231a of the current embodiment of the present invention are formed of copper (Cu). However, the present invention is not necessarily restricted thereto. In more detail, the discharge portions 231a of the first discharge electrode 231 can be formed of a transparent material, such as Indium Tin Oxide (ITO). In particular, in view of the fact that the discharge portions 231a are buried in the sheets 220, the discharge portions 231a can be formed of a conductive and anti-resistant metal, such as Ag, Al, etc., such that the PDP can quickly respond to a discharge, does not distort a signal, and reduces power consumption required for the sustain discharge.

The terminal portions 231b are formed on the dielectric portion 222, and are exposed to be connected to the signal transmitting element 240.

A gap A₁ between the terminal portions 231b is narrower than a gap L₁ between the discharge portions 231a in order to be connected to the signal transmitting element 240.

A thickness t₁ of the terminal portions 231b is 0.5˜2 μm. The thickness t₁ is determined based on a previous resistance value suitable for effecting a discharge in the discharge portions 231a and a speed of forming a thin film, and is used to prevent electrode 16 migration between the terminal portions 231b.

That is, if the thickness t₁ of the terminal portions 231b is less than 0.5 μm, the previous resistance value of the terminal portions 231b exceeds 100 Ω/m, and a current is rapidly decreased, so that it is difficult to effect the discharge using an input discharge voltage.

Also, if the thickness t₁ of the terminal portions 231b is greater than 2 μm, it takes a lot of time to form the thin film. In more detail, the terminal portions 231b are formed using a thin film forming process, such as ink jet printing or deposition, which deposits thinner materials than those used in a paste-type printing, thereby requiring a lot of time and expense to form the terminal portions 231b.

Also, if the thickness t₁ of the terminal portions 231b is greater than 2 μm, the dimensions of the terminal portions 231b arranged in the dielectric portion 222 are increased as much as the increased thickness, resulting in electrode migration between the electrodes.

To form the terminal portions 231b having a thickness t₁ of 0.5˜2 μm, the terminal portions 231b must be formed of a material suitable for forming the thin film and a fine pattern. The terminal portions 231b of the current embodiment of the present invention are formed of a Cr/Cu/Cr structure in which chrome (Cr) layers are formed on bottom and top surfaces of the terminal portions 231b and a copper (Cu) layer is formed between two chrome (Cr) layers.

The terminal portions 231b of the current embodiment of the present invention are formed of Cr/Cu/Cr. However, the present invention is not necessarily restricted thereto. In more detail, the terminal portions 231b can be formed of Cu, Al, and Ag, each consisting of nano-particles.

The terminal portions 231b of the current embodiment are formed of a different material from the discharge portions 231a and the connection portions 231c which are formed of Cu. However, the present invention is not necessarily restricted thereto, and can be formed of the same material as the discharge portions 231a and the connection portions 231c.

Since the terminal portions 231b are formed of a material suitable for forming the thin film and a fine pattern, it is easy to form the terminal portions 231b with a narrow width b₁. Therefore, the width b₁ of the terminal portions 231b of the current embodiment is smaller than the width b₂ of conductive wires 241 of the signal transmitting element 240. In this case, the gap A₁ between the terminal portions 231b is increased, which prevents the terminal portions 231b from being shorted due to electrode migration and impurity migration between the terminal portions 113 formed on the dielectric portion 222 and other substances, thereby reducing a failure rate of the terminal portions 231b.

The connection portions 231c electrically connect the discharge portions 231a and the terminal portions 231b, are buried in the sheets 220, have the same thickness as the discharge portions 231a, and are formed of Cu.

The connection portions 231c of the current embodiment are buried in the sheets 220. However, the present invention is not necessarily restricted thereto. In more detail, the connection portions 231c can be formed on the sheets 220 and have no restrictions as to their location.

The second discharge electrodes 232 cross the first discharge electrodes 231 and are symmetrical to the first discharge electrodes 231 in terms of structure. Like the first discharge electrodes 231, the second discharge electrodes 232 include discharge portions (not shown), terminal portions (not shown), and connection portions (not shown), and their detailed structure is the same as that of the first discharge electrodes 231.

The first discharge electrodes 231 of the current embodiment extend in a first direction, and the second discharge electrodes 232 cross the first discharge electrodes 231 to perform an addressing function. However, the present invention is not necessarily restricted thereto. In more detail, the PDP of the present invention includes an electrode that performs the addressing function to form a three-electrode structure.

The discharge portions 231a of the first discharge electrodes 231 and the discharge portions of the second discharge electrodes 232 surround the discharge cells 260 so that the sustain discharge is performed in a perpendicular direction at every perimeter position of the discharge portions partitioning the discharge cells 260. However, the present invention is not necessarily restricted thereto. In more detail, the first and second discharge electrodes 231 and 232 are stripe-shaped and can be buried in the barrier rib portions 211. In this case, the first and second discharge electrodes 231 and 232 have a discharge path of an opposite discharge rather than a surface discharge.

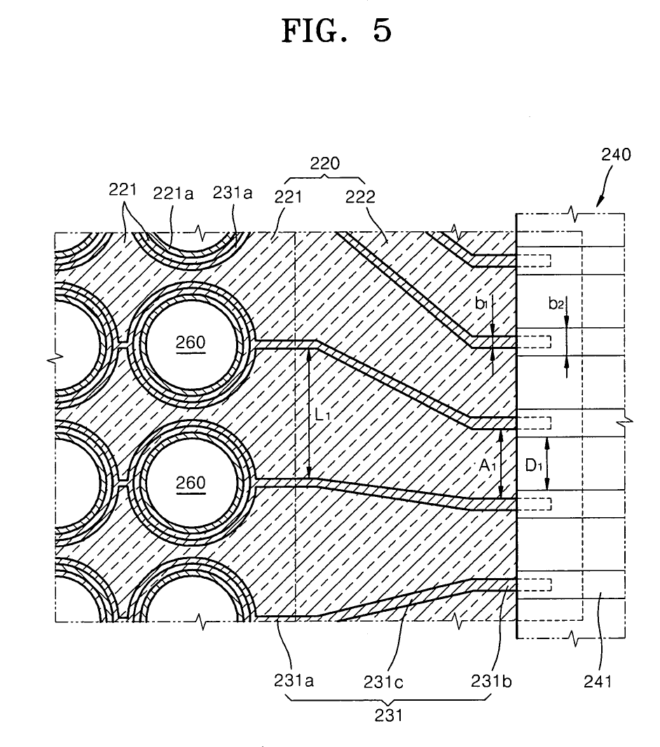

Referring to FIG. 5, the discharge portions 231a of the first discharge electrodes 231 and the discharge portions of the second discharge electrodes 232 have a circular ring shape. However, the present invention is not necessarily restricted thereto. In more detail, the discharge portions 231a of the first discharge electrodes 231 and the discharge portions of the second discharge electrodes 232 can be in the shape of an oval or polygon, such as a tetragon, a hexagon, an octagon, etc.

Since the discharge portions 231a of the first discharge electrodes 231 and the discharge portions of the second discharge electrodes 232 are buried in the sheets 220, the first discharge electrodes 231 and the second discharge electrodes 232 are not formed of a transparent material but are of a conductive metal, such as Ag, Al, or Cu, etc., such that the PDP 200 can quickly respond to the discharge, does not distort a signal, and reduces power consumption required for the sustain discharge.

The discharge portions 231a of the first discharge electrodes 231 and the discharge portions of the second discharge electrodes 232 are buried in the sheets 220. However, the present invention is not necessarily restricted thereto. In more detail, the first discharge electrodes 231 and the second discharge electrodes 232 can be formed on the first substrate 211 or the second substrate 212. In this case, the dielectric portion 222 can be formed on the first discharge electrodes 231 and the second discharge electrodes 232.

The signal transmitting element 240 is electrically connected to an operating circuit substrate (not shown) that operates the PDP 200, and is formed of a Flexible Printed Cable (FPC) or a Tape Carrier Package (TCP).

The signal transmitting element 240 are formed of the conductive wires 241 that transfers an electrical signal. The conductive wires 241 are electrically connected to the terminal portions 231b and are arranged at a predetermined gap D1.

The conductive wires 241 of the signal transmitting element 240 are connected to the discharge portions 231a of the first discharge electrodes 231 and the discharge portions of the second discharge electrodes 232 via an anisotropic conductive film.

A groove 211a is coated with the phosphor layer 250 according to red, green, and blue discharge cells 260 and is formed on the first substrate 211. The groove 211a is formed by sand blasting, etching, etc. on the first substrate 211 where the discharge cells 260 are formed.

The phosphor layers 250 have a component generating a visible light with ultraviolet rays. That is, a phosphor layer formed in a red light emitting discharge cell has a phosphor such as Y(V,P)O₄: Eu, a phosphor layer formed in a green light emitting discharge cell has a phosphor such as Zn₂SiO₄:Mn, YBO₃:Tb, and a phosphor layer formed in a blue light emitting discharge cell has a phosphor such as BAM:Eu.

The phosphor layers 250 of the current embodiment of the present invention are formed by coating the groove 211a formed on the first substrate 211 with a phosphor layer. However, the present invention is not necessarily restricted thereto. In more detail, the phosphor layers 250 can be formed in any portions of the discharge cells 260, for example, the sides of the barrier rib portions 221, in order to emit visible light using ultra violet rays generated by a plasma discharge.

The dielectric portion 222 is coated with a frit 270. The frit 270 is adhered between the substrates 210 and the dielectric portion 222 via a plastic process and seals the PDP 200.

After the PDP 200 is sealed, a discharge gas, such as Ne, Xe, or a mixture thereof, is injected into the PDP 200.

The manufacturing operations and functions of the PDP 200 according to the current embodiment of the present invention is described in detail as follows.

Operations of manufacturing the PDP 200 can be classified into forming the sheets 220, etching the substrates 210 and forming the phosphor layers 250, assembling, sealing, and injecting the discharge gas.

An operator buries the discharge portions 231a and the connection portions 231c of the first discharge electrodes 231, and the discharge portions and connection portions of the second discharge electrodes 232, sequentially deposits dielectric substances, forms the sheets 220, forms circular holes in the sheets 220 where the discharge cells 250 are arranged, and forms the barrier rib portions 221.

After the sheets 220 are formed, the terminal portions 231b are connected to ends of the connection portions 231c of the first discharge electrodes 231.

The terminal portions 231b are formed by ink jet printing or deposition to have a thickness of 0.5˜2 μm.

The terminal portions 231b of the current embodiment of the present invention are formed of a Cr/Cu/Cr structure in which Cr layers are formed in bottom and top surfaces of the terminal portions 231b and the Cu layer is formed between two Cr layers. Using ink jet printing a pattern of the terminal portions 231b is formed using a liquid material. Using deposition pattern of the terminal portions 231b is formed by depositing the materials.

The width b, of the terminal portions 231b of the current embodiment is smaller than the width b₂ of the conductive wires 241 of the signal transmitting element 240.

Likewise, the terminal portions of the second discharge electrodes 232 are symmetrical to the terminal portions 231b of the first discharge electrodes 231.

Protection layers 221a formed of MgO are formed on the sides of the barrier rib portions 221 using vacuum deposition.

The groove 211a is formed on the first substrate 211 by etching a portion of the first substrate 211 where the discharge cells 260 are arranged using a glass-cutting method such as sand blast, etching, etc. The phosphor layer 250 is formed by coating the groove 211a with the phosphor substance.

The sheets 220 are inserted between the first and second substrates 211 and 212. In this assembling operation, the frit 270 is properly coated to be arranged between the substrates 210 and the dielectric portion 222 of the sheets 220.

After the sealing has been completed, a vacuum exhaust operation is performed, and the discharge gas is injected.

After the discharge gas has been completely injected, the terminal portions 231b are connected to the conductive wires 241 of the signal transmitting element 240 via the anisotropic conductive film.

After the manufacturing of the PDP 200 and the injection of the discharge gas have been completed, a predetermined address voltage is supplied between the first and second discharge electrodes 231 and 232 from an external power source, and the address discharge is generated, so that a discharge cell where a sustain discharge is generated is selected from the discharge cells 260.

If a discharge sustain voltage is supplied between the selected discharge cell 260 and the first and second discharge electrodes 231 and 232, the wall charges accumulated on the sides of the barrier rib portions 221 move due to the discharge portions 231a of the first discharge electrodes 231 and the discharge portions of the second discharge electrodes 232, thereby generating the sustain discharge. An energy level of the discharge gas excited by the sustain discharge is reduced, thereby discharging ultraviolet rays.

The ultraviolet rays excite the phosphor layers 250. An energy level of the excited phosphor layers 250 is reduced to emit a visible light. The emitted visible light is transmitted through the first substrate 211 and forms an image to be recognized by a user.

The terminal portions 231b of the discharge electrodes are formed of a Cr/Cu/Cr structure capable of forming a fine pattern and having a thickness t, of 0.5˜2 μm. Therefore, the terminal portions 231b have small dimensions and are firmly formed on the dielectric portion 222, thereby preventing electrode migration between the terminal portions 231b and reducing a failure rate of the terminal portions 231b.

Also, the width b₁ of the terminal portions 231b of the current embodiment is smaller than the width b₂ of the conductive wires 241 of the signal transmitting element 240, thereby preventing the terminal portions 231b from being shorted due to electrode migration and impurity migration between the terminal portions 113, thereby reducing a failure rate of the terminal portions 231b.

The discharge portions 231a of the first discharge electrodes 231 and the discharge portions of the second discharge electrodes 232 surround the discharge cells 260 so that the sustain discharge is effected in a perpendicular direction at every perimeter position of the discharge cells 260. Therefore, the PDP 200 of the current embodiment of the present invention has a relatively wide discharge area, thereby increasing light emitting brightness and light emitting efficiency.

Since the PDP 200 includes the sheets 220, it is not necessary to deposit barrier rib portions on a substrate in order to form the discharge cells 260. That is, the discharge cells 260 are formed by forming the sheets 220 and square holes in a space where a discharge is generated, thereby simplifying the manufacturing process and reducing the manufacturing costs.

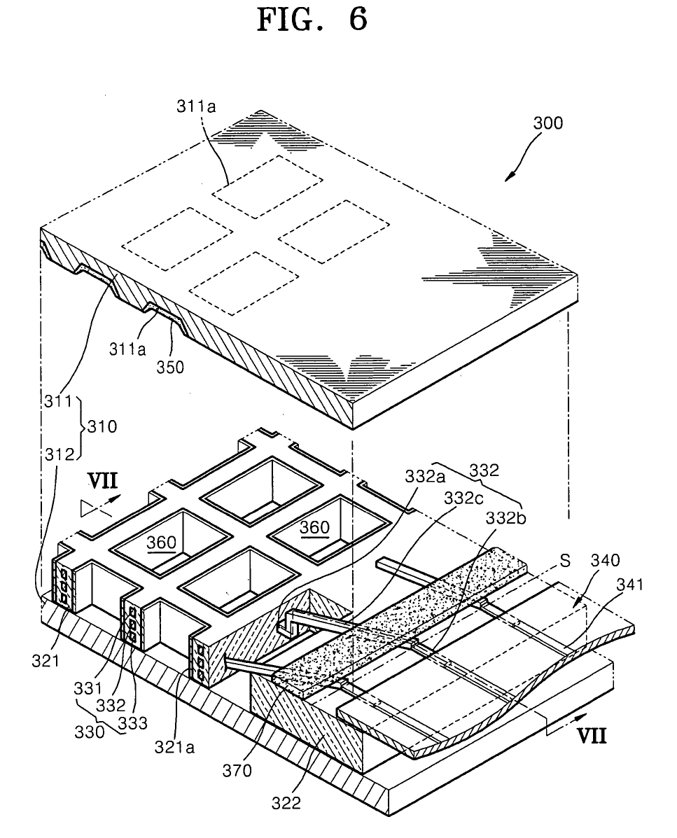

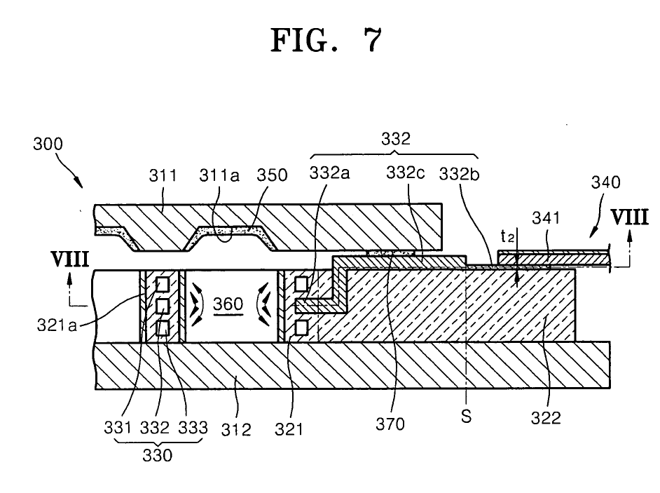

A PDP 300 according to another embodiment of the present invention is described 2 below with reference to FIGS. 6 through 8.

Referring to FIGS. 6 through 8, the PDP 300 includes a pair of substrates 310, barrier 4 rib portions 321, dielectric portion 322, discharge electrodes 330, signal transmitting element 340, and phosphor layers 350.

The pair of substrates 310 are a first substrate 311 and a second substrate 312 which are spaced apart from each other by a predetermined gap and face each other. The first substrate 311 is formed of glass through which visible light is transmitted.

The barrier rib portions 321 are stacked on the second substrate 312 and partition discharge cells 360 where a discharge is generated, along with the pair of substrates 310.

The discharge cells 360 partitioned by the barrier rib portions 321 have rectangular cross sections.

The dielectric portion 322 are arranged on the outside of the barrier rib portions 321 formed on edges of the PDP 300.

The dielectric portion 322 are stacked on the second substrate 312 and are connected to the barrier rib portions 321.

The barrier rib portions 321 are formed of a dielectric substance. Discharge portions of first, second, and third discharge electrodes 331, 332, and 333 are buried in the dielectric substance.

The dielectric substance forming the barrier rib portions 321 accumulates wall charges by inducing charges, while preventing the first, second, and third discharge electrodes 331, 332, and 333 from sending a current therebetween and being damaged due to collisions between charged particles and the first, second, and third discharge electrodes 331, 332, and 333. The dielectric substance can be PbO, B₂O₃, SiO₂, etc.

The barrier rib portions 321 and the dielectric portion 322 of the PDP 300 are connected to each other and are formed of the same material. However, the present invention is not necessarily restricted thereto. In more detail, the barrier rib portions 321 and the dielectric portion 322 may not be connected to each other. In this case, the barrier rib portions 321 and the dielectric portion 322 are formed of dielectric substances having a different dielectric characteristics.

The sides of the barrier rib portions 321 contacting the discharge cells 360 are covered with protection layers 321a that are formed of MgO.

The discharge electrodes 330 include the first discharge electrodes 331, the second discharge electrodes 332 spaced apart from the first discharge electrodes 331, and the third discharge electrodes 333 spaced apart from the second discharge electrodes 332.

The first discharge electrodes 331 and the third discharge electrodes 333 extend in a similar direction, and the second discharge electrodes 332 cross the first discharge electrodes 331 and the third discharge electrodes 333, so that the second discharge electrodes 332 serve as address electrodes that perform an addressing function.

The present invention is not necessarily restricted to the above structure of the first, second, and third discharge electrodes 331, 332, and 333. In more detail, among the first, second, and third discharge electrodes 331, 332, and 333, first and second discharge electrodes extend in a similar direction, and the other discharge electrodes cross the first and second discharge electrodes. In this case, the first and second discharge electrodes serve as scan electrodes and common electrodes, and the third discharge electrodes serve as address electrodes.

Each of the discharge electrodes 330 includes discharge portions, terminal portions, and connection portions. The second discharge electrodes 332 are as follows. Referring to FIGS. 5 through 7, S is shown to divide discharge portions 332a and terminal portions 332b.

The discharge portions 332a of the second discharge electrodes 332 are arranged inside the barrier rib portions 321, directly effect the discharge, have a thickness of 5˜10 μm, and are formed of Ag.

The terminal portions 332b contact the dielectric portion 322 and are exposed outside to be connected to the signal transmitting element 340.

A gap A₂ between the terminal portions 332b is narrower than a gap L₂ between the discharge portions 332a in order to be connected to the signal transmitting element 340.

A thickness t₂ of the terminal portions 332b is 0.5˜2 μm. The thickness t₂ is determined based on a previous resistance value suitable for effecting a discharge in the discharge portions 332a and a speed of forming a thin film, and is used to prevent electrode migration between the terminal portions 332b.

That is, if the thickness t₂ of the terminal portions 332b is less than 0.5 μm, the previous resistance value of the terminal portions 332b exceeds 100 Ω/m, and a current is rapidly decreased, so that it is difficult to effect the discharge using an input discharge voltage.

Also, if the thickness t₂ of the terminal portions 332b is greater than 2 μm, it takes a lot of time to form the thin film. In more detail, the terminal portions 332b are formed using a thin film forming process, such as ink jet printing or deposition, which deposits thinner materials than those used in a paste-type printing, thereby requiring a lot of time and expense to form the terminal portions 332b.

Also, if the thickness t₂ of the terminal portions 332b is greater than 2 μm, dimensions of the terminal portions 332b arranged in a dielectric layer are increased as much as the increased thickness, resulting in electrode migration between the electrodes.

To form the terminal portions 332b having a thickness t₂ of 0.5˜2 μm, the terminal portions 332b must be formed of a material suitable for forming the thin film and a fine pattern. The terminal portions 332b of the current embodiment of the present invention are formed of Cu, whereas the discharge portions 332a and the connection portions 332c are formed of Ag.

A width b₃ of the terminal portions 332b of the current embodiment is the same as a width b₄ of conductive wires 341 of the signal transmitting element 340.

The connection portions 332c electrically connect the discharge portions 332a and the terminal portions 332b, and have the same thickness as the discharge portions 332a.

A portion of the connection portions 332c is buried in the dielectric portion 322 and other portions of the connection portions 332c are exposed on the dielectric portion 322. The connection portions 332c are formed of Ag.

The first discharge electrodes 331 and the third discharge electrodes 333 cross the second discharge electrodes 332 are symmetrical to each other. Like the second discharge electrodes 332, the first and third discharge electrodes 331 and 333 include discharge portions (not shown), terminal portions (not shown), and connection portions (not shown), and their detailed structure is the same as that of the second discharge electrodes 332.

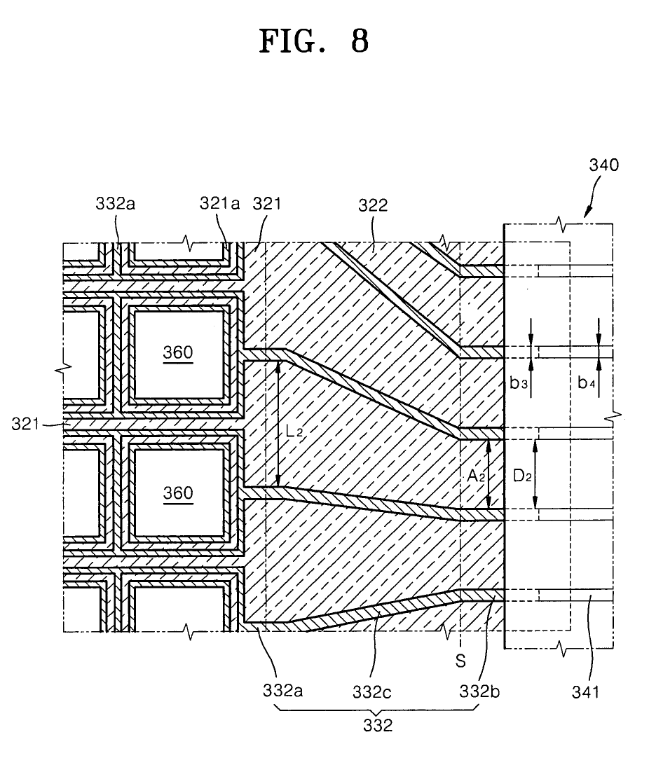

The discharge portions of the first discharge electrodes 331, the discharge portions 332a of the second discharge electrodes 332, and the discharge portions of the third discharge electrodes 333 surround the discharge cells 360, and are in a ladder shape as illustrated in FIG. 8.

The signal transmitting element 340 is electrically connected to an operating circuit substrate (not shown) that operates the PDP 300, and is formed of FPC or TCP.

The signal transmitting element 340 is formed of the conductive wires 341 that transfer electrical signals. The conductive wires 341 are electrically connected to the terminal portions 332b and are spaced apart from each other by predetermined gaps D₂.

The conductive wires 341 of the signal transmitting element 340 are connected to the discharge portions of the discharge electrodes 330 via an anisotropic conductive film.

A groove 311a is coated with the phosphor layer 350 according to red, green, and blue discharge cells 360 and is formed on the first substrate 311. The groove 311a is formed by sand blasting, etching, etc. on the first substrate 311 where the discharge cells 360 are formed. Since the dielectric layer 350 is the same as the phosphor layer 250, the description of the dielectric substance thereof has been omitted

A frit 370 is coated between the dielectric portion 322 and the first substrate 311. The frit 370 seals the substrates 310 via a plastic process.

After the PDP 300 has been sealed, a discharge gas, such as Ne, Xe, or a mixture thereof, is injected into the PDP 300.

The manufacturing operations and functions of the PDP 300 according to the current embodiment of the present invention are described in detail as follows.

Operations of manufacturing the PDP 300 can be classified into forming the barrier rib portions 321 and the dielectric portion 322 on the second substrate 312, forming the phosphor layers 350 on the first substrate 311, assembling, sealing, and injecting the discharge gas.

The barrier rib portions 321 are formed by stacking dielectric substances on the second substrate 312 in which the discharge portions of the third discharge electrodes 333, the discharge portions 332a of the second discharge electrodes 332, and the discharge portions of the first discharge electrodes 331 are sequentially buried using sand blasting, screen printing, etc.

The dielectric portion 322 are formed by stacking dielectric substances on the second substrate 312 in which the third discharge electrodes 333, the second discharge electrodes 332, and the first discharge electrodes 331 are sequentially buried in the dielectric portion 322 using sand blasting, screen printing, etc.

After the barrier rib portions 321 and the dielectric portion 322 are formed, the terminal portions 332b are connected to ends of the connection portions 332c of the second discharge electrodes 332.

The terminal portions 332b are formed by ink jet printing or deposition to have a thickness of 0.5˜2 μm. Using ink jet printing a pattern of the terminal portions 332b is formed using a liquid material including Cu. Using deposition a pattern of the terminal portions 332b is formed by depositing Cu.

The width b₃ of the terminal portions 332b of the current embodiment of the present invention is the same as the width b₄ of the conductive wires 341 of the signal transmitting element 340.

Likewise, the terminal portions of the first discharge electrodes 331 and the third discharge electrodes 333 are symmetrical to the terminal portions 332b of the second discharge electrodes 332.

Protection layers 321a of MgO are formed on the sides of the barrier rib portions 321 using vacuum deposition.

The groove 311a is formed on the first substrate 311 by etching a portion of the first substrate 311 where the discharge cells 360 are arranged using a glass cutting method such as sand blasting, etching, etc. The phosphor layer 350 is formed by coating the groove 311a with a phosphor substance.

To assemble the first and second substrates 311 and 312, the frit 370 is properly coated to be arranged between the first substrate 310 and the dielectric portion 322.

After the sealing has been completed, a vacuum exhaust operation is performed, and the discharge gas is injected.

After the discharge gas has been completely injected, the terminal portions 332b are connected to the conductive wires 341 of the signal transmitting element 340 via the anisotropic conductive film.

After the manufacturing of the PDP 300 and the injection of the discharge gas has been completed, a predetermined address voltage is supplied between the second discharge electrodes 332 and one of the first and second discharge electrodes 331 and 333 that serve as the scan electrodes from an external power source, and the address discharge is generated, so that a discharge cell where a sustain discharge is generated is selected from the discharge cells 360.

If a discharge sustain voltage is supplied between the first and third discharge electrodes 331 and 333 of the selected discharge cell 360, the wall charges accumulated on the sides of the barrier rib portions 321 move due to the first discharge electrodes 331 and the third discharge electrodes 333, thereby generating the sustain discharge. An energy level of the discharge gas excited by the sustain discharge is reduced, thereby emitting ultraviolet rays.

The ultraviolet rays excite the phosphor layers 250 coated in the discharge cells 360. An energy level of the excited phosphor layers 350 is reduced to emit visible light. The emitted visible light is transmitted through the first substrate 311 and forms an image to be recognized by a user.

The terminal portions 332b of the discharge electrodes of the current embodiment are formed of Cu capable of forming a fine pattern and having a thickness t₂ of 0.5˜2 μm. Therefore, the terminal portions 332b have small dimensions and are firmly formed on a dielectric layer, thereby preventing electrode migration between the terminal portions 332b and reducing a failure rate of the terminal portions 332b.

The discharge portions of the first, second, and third discharge electrodes 331, 332, and 333 surround the discharge cells 360 so that the sustain discharge is effected at every perimeter position of the discharge cells 360. Therefore, the PDP 300 of the current embodiment of the present invention has a relatively wide discharge area, thereby increasing light emitting brightness and light emitting efficiency.

As described above, the PDP 300 forms terminal portions having a thickness of 0.5˜2 μm, which prevents the terminal portions from being shorted due to electrode migration and impurity migration between the terminal portions and other substances, thereby improving quality of the PDP 300, reducing a failure rate of terminal portions, and reducing the manufacturing costs.

In particular, the PDP according to the present invention can easily implement a high density and precision structure of a terminal part when realizing a Full High Definition (FHD) image.

The PDP according to the present invention has a relatively wide discharge area, thereby increasing light emitting brightness and light emitting efficiency since discharge portions of discharge electrodes are buried in a sheet or barrier rib portions to surround discharge cells.

The PDP according to the present invention includes a sheet, thereby reducing manufacturing process and costs.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a pair of substrates spaced apart from each other and facing each other;
a sheet interposed between the pair of substrates and including barrier rib portions partitioning discharge cells along with the pair of substrates, and a dielectric portion arranged on edges of the sheet;
discharge electrodes including discharge portions arranged within the barrier rib portions and adapted to effect a discharge, terminal portions contacting the dielectric portion, having a thickness of 0.5˜2 μm, and spaced apart from each other, and connection portions connecting the discharge portions to the terminal portions;
a signal transmitting element including conductive wires contacting the terminal portions and spaced apart from each other;
phosphor layers arranged within the discharge cells; and
a discharge gas contained within the discharge cells.

2. The PDP of claim 1, wherein the discharge portions surround at least part of the discharge cells.

3. The PDP of claim 1, wherein the discharge portions are stripe-shaped.

4. The PDP of claim 1, wherein the terminal portions comprise a different material from that of the discharge portions.

5. The PDP of claim 1, wherein the terminal portions comprise a different material from that of the connection portions.

6. The PDP of claim 1, wherein the terminal portions comprise a material selected from a group consisting of Cr/Cu/Cr, Ag, Cu, and Al.

7. The PDP of claim 1, wherein a width of the terminal portions is smaller than a width of the conductive wire of the signal transmitting element.

8. The PDP of claim 1, wherein the signal transmitting element comprises a Flexible Printed Cable (FPC).

9. The PDP of claim 1, wherein the signal transmitting element comprises a Tape Carrier Package (TCP).

10. The PDP of claim 1, wherein the conductive wires of the signal transmitting element and the terminal portions are connected via an anisotropic conductive film.

11. A Plasma Display Panel (PDP), comprising:
a pair of substrates spaced apart from each other and facing each other;
barrier rib portions interposed between the pair of substrates and partitioning discharge cells along with the pair of substrates;
discharge electrodes including discharge portions arranged in the pair of substrates and adapted to effect a discharge, terminal portions having a thickness of 0.5˜2 μm and spaced apart from each other, and connection portions connecting the discharge portions to the terminal portions;
a signal transmitting element including conductive wires contacting the terminal portions and spaced apart from each other;
phosphor layers arranged within the discharge cells; and
a discharge gas contained within the discharge cells.

12. The PDP of claim 11, wherein the discharge portions surround at least part of the discharge cells.

13. The PDP of claim 11, wherein the discharge portions are stripe-shaped.

14. The PDP of claim 11, wherein the terminal portions comprise a same material as that of the discharge portions.

15. The PDP of claim 11, wherein the terminal portions comprise a different material from that of the connection portions.

16. The PDP of claim 11, wherein the terminal portions comprise a material selected from a group consisting of Cr/Cu/Cr, Ag, Cu, and Al.

17. The PDP of claim 11, wherein a width of the terminal portions is smaller than a width of the conductive wire of the signal transmitting element.

18. The PDP of claim 11, wherein the signal transmitting element comprises a Flexible Printed Cable (FPC).

19. The PDP of claim 11, wherein the signal transmitting element comprises a Tape Carrier Package (TCP).

20. The PDP of claim 11, wherein the conductive wires of the signal transmitting element and the terminal portions are connected via an anisotropic conductive film.
